(19) United States
(12) Patent Application Publication
(10) Pub. No.: US 2008/0185267 A1
(43) Pub. Date: Aug. 7, 2008

(54) SYSTEM FOR CONVEYING AND/OR SELECTING FRUIT AND/OR VEGETABLE PRODUCTS

(76) Inventor: Angelo Benedetti, Lugo (RA) (IT)

Correspondence Address: William J. Cooper, Esq.;Eschweiler & Associates, LLC, Suite 1000, 629 Euclid Avenue, Cleveland, OH, 44114, US

(21) Appl. No.: 11/966,555

(22) Filed: Dec. 28, 2007

Related U.S. Application Data
(63) Continuation of application No. PCT/EP2006/063562, filed on Jun. 26, 2006.

(30) Foreign Application Priority Data
Jun. 28, 2005 (IT) BO2005A000425

(51) Int. Cl. B65G 47/96; G06F 7/00

(52) U.S. Cl. 198/705; 700/230

(57) ABSTRACT

A system for conveying and/or selecting fruit and/or vegetable products that mitigates damage, to the fruit, and/or vegetable products is disclosed. The system comprises a plurality of buckets presenting respective resting surfaces for one or more fruit and/or vegetable products; a conveying line of said buckets along a horizontal axis (X); at least one discharge station arranged by the side of said conveying line; and an assembly for controlling the rotation of the buckets between a conveying position and a discharge position of the product towards said station, where respective resting surfaces of the buckets are upwardly concave, and at least one part of the resting surfaces of the bucket is defined by a plurality of rollers turning about their longitudinal axis, which is parallel to the horizontal axis (X).

### REFERENCE TO RELATED APPLICATION(S)

This application is a continuation of PCT/EP2006/063562, filed Jun. 26, 2006, that claims the benefit of the priority date of BO2005A000425, filed on Jun. 28, 2005, the contents of both of which are herein incorporated by reference in their entireties.

### FIELD

The disclosure herein relates to harvesting produce, and more particularly to a system for conveying and selecting fruit and/or vegetable products.

### BACKGROUND

As known, systems of the type indicated above comprise a plurality of buckets, in each of which one or more fruit and/or vegetable products are accommodated, a conveying line of the aforesaid buckets, a member for determining certain features of the fruit and/or vegetable products, such as weight, size, color, etc., a plurality of discharge and product packaging stations, and an assembly controlling the conveyance of products to the latter fruit and/or vegetable product stations according to the determined features. The bucket is nothing more than a container presenting a bottom wall and four preferably outwardly slanted side walls. The assembly which controls the discharge of the fruit and/or vegetable products from the bucket comprises an actuator which controls the rotation of the bucket about a horizontal axis so that the fruit and/or vegetable products either drop and/or roll out of respective buckets.

One of the main problems of the above described system is that such a system for discharging the fruit and/or vegetable products from, the bucket may compromise the product integrity; consider, for example, products in bunches, such as certain type of tomatoes or grapes, or products with delicate skins. It is apparent that in the discharge system described above the quantity of fruit and/or vegetable products which must be discarded because they are damaged by dropping from the bucket onto the conveying belt of the discharge station is high.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A system for conveying and/or selecting fruit and/or vegetable products that mitigates damage to the fruit and/or vegetable products is disclosed. The system comprises a plurality of buckets presenting respective resting surfaces for one or more fruit and/or vegetable products; a conveying line of said buckets along a horizontal axis (X); at least one discharge station arranged by the side of said conveying line; and an assembly for controlling the rotation of the buckets between a conveying position and a discharge position of the product towards said station, where respective resting surfaces of the buckets are upwardly concave, and at least one part of the resting surfaces of the bucket is defined by a plurality of rollers turning about their longitudinal axis, which is parallel to the horizontal axis (X).

To the accomplishment of the foregoing and related ends, the following description and annexed drawings set forth certain illustrative aspects and implementations. These are indicative of but a few of the various ways in which one or more aspects may be employed. Other aspects, advantages, and novel features will become apparent from the following detailed description when considered in conjunction with the annexed drawings

### BRIEF DESCRIPTION OF THE DRAWINGS

FIG. 1 illustrates a perspective view of a system for conveying and/or selecting fruit and/or vegetable products as described herein.

FIG. 2 illustrates a side view of a container of the system in FIG. 1.

FIG. 3 illustrates a side view of the container in FIG. 2 in a different working position.

FIG. 4 illustrates a plan view of the container in FIG. 2.

FIG. 5 illustrates a frontal view of the container in FIG. 2.

### DETAILED DESCRIPTION

The following discussion is now marie, with reference to the drawings, wherein like reference numerals are used to refer to like elements throughout. In the following description, for purposes of explanation, numerous, specific details are set forth in order to provide a more thorough understanding. It may be evident, however, that the claimed subject matter may be practiced with or without these specific details. In other instances, well-known structures and devices are illustrated in block diagram, or other, form to facilitate the description.

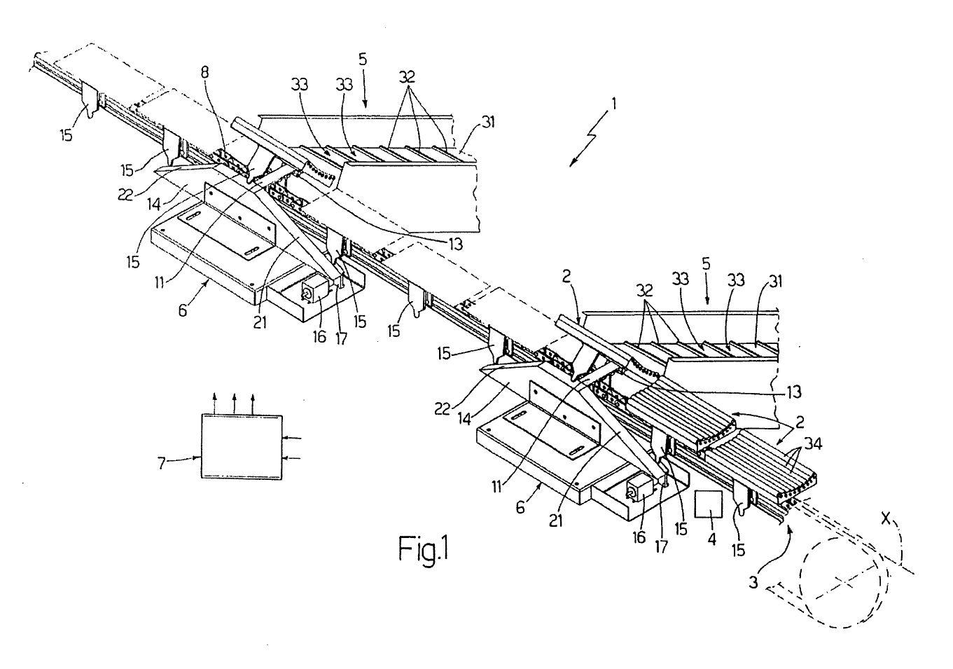

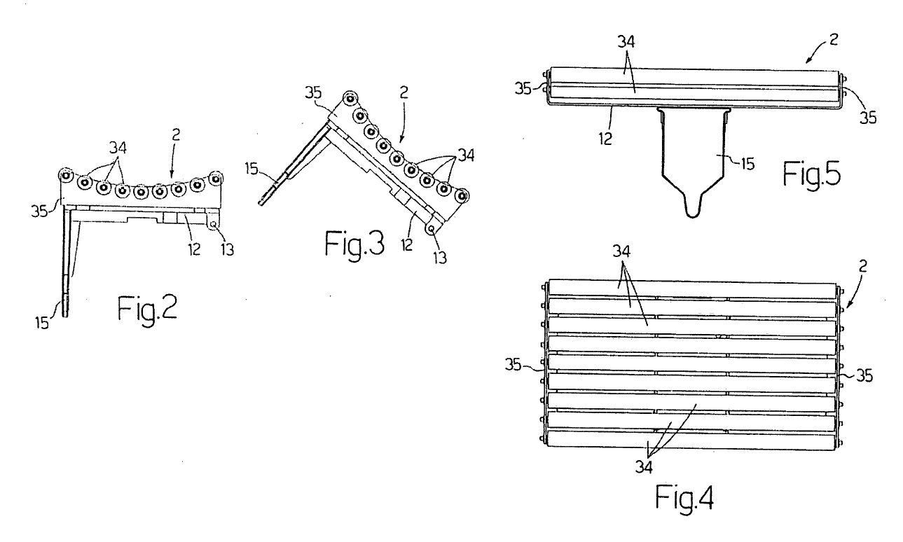

With reference to FIG. 1, a system 1 for conveying and/or selecting fruit and/or vegetable products is illustrated. The system comprises a plurality of buckets 2 within which can be placed one or more fruit and/or vegetable products in a station (not shown). A conveying line 3 of aforesaid buckets 2 is depicted along a horizontal axis X, as is means 4 (of a known type and thus not illustrated) for determining at least one feature of the fruit and/or vegetable products accommodated in the buckets 2. A plurality of discharge and packaging stations 5 are arranged at select locations along-side the conveying line 3. Respective assemblies 6 are included for the stations 5 for controlling rotation about an axis parallel to axis X of the buckets 2 between a conveying position and a discharge position of the products towards one of the stations 5.

An electronic control unit 7 is operatively coupled to the conveying line 3, the feature determining means 4, the stations 5 and the assemblies 6. The conveying line 3 is of the known type and in particular presents a mobile chain 8 along a loop route. The conveying line 3 supports, according to a uniform distribution, a plurality of brackets 11 which support respective plates 12. In particular, each plate 12 is hinged to the respective bracket 11 so that it can turn about a horizontal pin 13 from a conveying position in which it is horizontal to a discharge position in which it is slanted by a predetermined angle. The hinging pin 13 is arranged on the side of the line 3 facing stations 5. Each plate 12 integrally supports a respective bucket 2.

The assembly 6 is of the known type and in particular shown in patent application BO2003A00280 by the instant/same applicant. The assembly 6 comprises a cam plate 14 installed by the side of the line 3 at each station 5 on the opposite side, a tappet profile 15 which extends downwards from a corresponding plate 12, and an actuator 16 arranged near each cam plate 14. The actuator 16 comprises a horizontal stem 17 mobile between an extracted position in which it does not interact with the tappet profile 15 whereby the plate 12 and its tappet profile 15 remain in the conveying position and a retracted position in which, by means of a body 18, the seem 17 presses the tappet profile 15 against the cam plate 14 determining a rotation about the pin 13 of the plate 12 in contact between the tappet profile 15 and an upward ramp 21 defined on the cam plate 14. Now, such contact increases the rotation of the plate 12 and its bucket 2, favouring the release of the product from the bucket 2. Of course, the cam plate 14 presents in sequence a downward ramp 22 which makes the plate: 12 return to its horizontal conveying position.

With reference to FIG. 1, station 5 comprises a conveyor belt 31 and respective handling means managed by unit 7 and not shown being of a known type. The conveyor belt 31 presents, for its length, a plurality of appendixes 32 which define there-between a plurality of seats 33 in which the one or more fruit and/or vegetable products are discharged from the bucket 2.

With reference to FIGS. from 3 to 5, bucket 2 is defined by a plurality of rollers 34 carried by two side fins 35 which extend upwards from plate 12. The rollers 34 are parallel to axis X, are idly mounted and define an upward concave resting surface for the one or more fruit and/or vegetable products.

In use, one or more of the features of the one or more fruit and/or vegetable products conveyed by each bucket 2 are determined by means 4; features such as weight, size, colour, etc., for example. On the basis of such features, unit 7 selects the station 5 where to discharge the fruit and/or vegetable products. Now, each passage of the bucket 2 at the selected station 5, the unit 7 activates the assembly 6 which controls the rotation of a predetermined angle (according to the dimensions in height of the cam plate 14) of the bucket 2. The fruit and/or vegetable products from the bucket 2 slips essentially parallelly to itself into a seat 33 of the belt 31. Such slipping occurs smoothly by effect of the rotation of the rollers 34 impressed by the fruit and/or vegetable products.

The unit 7 according to the features of fruit and/or vegetable products conveyed by buckets 2 may carry out different operating modes. A first mode may envisage discharge into a seat 33 of only the fruit and/or vegetable products presenting a predetermined grade (or colour, or size) to reach a certain total weight or number of products. A second mode may envisage discharge into a seat 33 of the fruit, and/or vegetable products, also of different grade (or colour, or size) to reach a determined total weight or number of products. Once the total weight or selected number of products in the seat 33 is reached, the latter is advanced to a packaging member of the known type and for this reason not shown, thus taking a new seat 33 at the line 3.

According to implementing the above, advantages obtained thereby are apparent, and numerous. In particular, it has been carried out a system which allows the fruit and/or vegetable products to be conveyed from the conveying buckets to the discharge and packaging station by substantially slipping rather than dropping and/or rolling. This type of transfer mitigates collisions between the various parts of bunches of product and the collision of the product onto the discharge station conveyor belt. Essentially, with this type of smooth transfer, the integrity of the product is safeguarded and thus rejects of the same are considerably reduced. It is apparent that this positively influences product cost. It must be underlined that smooth transfer is obtained with a bucket which is easy to construct and to assemble. Furthermore, considering that a gap is determined between the various adjacent rollers, possible impurities may drop clown through such gaps and therefore not channel towards the packaging system.

It is finally apparent that changes and variants can be made to the system 1 here described and shown without however departing from the protective scope of the present invention.

In particular, the bucket 2 may envisage only a reduced portion defined by the rollers 34. Furthermore, at least one roller 34 may be driven and therefore help the slipping of the product towards the belt 31.

It will be appreciated that, as used in this application and appended claims, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been illustrated and described with respect to one or more

implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that, the terms “includes”, “having”, “has”, “with”, or variants thereof are used in either the detailed description or the claims, such terms are intended to be inclusive in a manner similar to the term “comprising.”

1) A system for conveying and/or selecting fruit and/or vegetable products, comprising:
a plurality of buckets presenting respective resting surfaces for one or more fruit and/or vegetable products;
a conveying line of said buckets along a horizontal axis (X);
at least one discharge station arranged by the side of said conveying line; and
an assembly for controlling the rotation of the buckets between a conveying position and a discharge position of the product towards said station;
respective resting surfaces of the buckets being upwardly concave, and at least one part of the resting surfaces of the bucket defined by a plurality of rollers turning about their longitudinal axis, which is parallel to the horizontal axis (X).

2) The system of claim 1, at least one of the rollers being driven.

3) The system of claim 1, comprising:
means for determining at least one feature of the fruit and/or vegetable products accommodated in the buckets;
a plurality of stations and corresponding assemblies, for the respective stations; and
an electronic control unit (7) configured to control the respective operations of the assemblies based upon the at least one feature determined by the determining means.

4) The system of claim 3, the stations comprising respective conveyor belts on whose surfaces are provided seats in which the products of the buckets are transferred.
